(19) United States
(12) Patent Application Publication
(10) Pub. No.: US 2012/0084800 A1
(43) Pub. Date: Apr. 5, 2012

(54) INFORMATION PROCESSING APPARATUS AND POWER CONTROL METHOD

(75) Inventors: Kinji HARA, Hamura-shi (JP); Tooru MAMATA, Akiruno-shi (JP); Toru HANADA, Oume-shi (JP)

(73) Assignee: KABUSHIKI KAISHA TOSHIBA, Tokyo (JP)

(21) Appl. No.: 13/229,501

(22) Filed: Sep. 9, 2011

(30) Foreign Application Priority Data
Sep. 30, 2010 (JP) 2010-223188
Mar. 24, 2011 (JP) 2011-065274

(51) Int. Cl. G11B 17/04

(52) U.S. Cl. 720/601; G9B/17.013

(57) ABSTRACT

According to one embodiment, an information processing apparatus includes: an optical disk device; an optical disk device controller which opens a tray provided in the optical disk device; a receiver which receives a command for instructing to open the tray; a detector which detects a movement of the information processing apparatus which incorporates the optical disk device; a power controller which controls supply of power to each component of the information processing apparatus; and a power determining module which determines whether the information processing apparatus is connected to an external power supply. The power controller starts the supply of power to the optical disk device if the command is received while stopping the supply of power to the optical disk device and if the movement is not detected and the information processing apparatus is connected to the external power supply.

### CROSS REFERENCE TO RELATED APPLICATION(S)

The application is based upon and claims the benefit of priority from Japanese Patent Application No. 2010-223188 filed on Sep. 30, 2010, and Japanese Patent Application No. 2011-065274 filed on Mar. 24, 2011; the entire content of which are incorporated herein by reference.

### FIELD

Embodiments described herein relate generally to an information processing apparatus and a power control method.

### BACKGROUND

A notebook personal computer capable of being driven by a battery has recently been further reduced in weight and allowed to be used even while being not connected to an external power supply, and therefore, such a notebook personal computer can be carried around while a system is kept in an operating state.

A personal computer equipped with an optical disk device is provided at its lateral face with an eject button for providing an instruction for ejection of a tray of the optical disk device. Hence, when such a personal computer is carried around while a system is kept in an operating state, this eject button might be operated by mistake and the tray might be opened accidentally. For example, when the eject button is pressed by mistake inside a bag and the tray is opened accidentally, the tray might come into contact with other objects or the like inside the bag and the tray might be broken.

Examples of methods for solving this problem include a method for determining whether or not a personal computer is in a stationary state by using an acceleration sensor provided in the personal computer and for automatically disabling an eject button when the personal computer is in a non-stationary state.

### BRIEF DESCRIPTION OF THE DRAWINGS

FIG. 1 is a diagram showing an outer appearance of an information processing apparatus according to an embodiment.

FIG. 2 is a block diagram showing functions of the information processing apparatus according to the embodiment.

FIG. 3 is a diagram for describing power control performed by the information processing apparatus according to the embodiment.

FIG. 4 is a flow chart showing a procedure of power control performed by the information processing apparatus according to a first example of the embodiment.

FIG. 5 is a flow chart showing a procedure of power control performed by the information processing apparatus according to a second example of the embodiment.

FIG. 6 is a flow chart showing a procedure of power control performed by the information processing apparatus according to a third example of the embodiment.

### DETAILED DESCRIPTION OF THE EMBODIMENTS

In general, according to one exemplary embodiment, an information processing apparatus includes: an optical disk device; an optical disk device controller which opens a tray provided in the optical disk device; a receiver which receives a command for instructing to open the tray; a detector which detects a movement of the information processing apparatus which incorporates the optical disk device; a power controller which controls supply of power to each component of the information processing apparatus; and a power determining module which determines whether the information processing apparatus is connected to an external power supply. The power controller starts the supply of power to the optical disk device if the command is received while stopping the supply of power to the optical disk device and if the movement is not detected and the information processing apparatus is connected to the external power supply.

Hereinafter, an embodiment will be described with reference to the drawings.

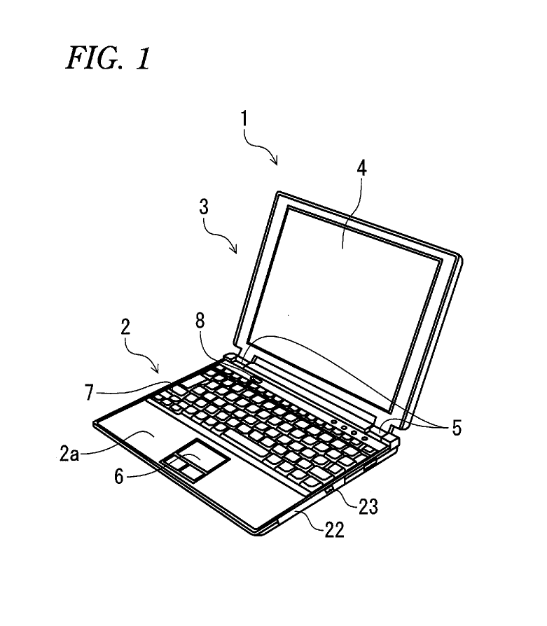

First, an information processing apparatus according to the embodiment will be described with reference to FIG. 1. FIG. 1 is a diagram showing an outer appearance of the information processing apparatus according to the embodiment. The embodiment will be described using a personal computer 1 as an example of the information processing apparatus. The personal computer 1 according to the embodiment includes an Optical Disk Drive (ODD) 22.

In the personal computer 1, a computer main unit 2 and a display unit 3 are provided so as to be rotatable via hinges 5. The computer main unit 2 has: a touchpad 6; a keyboard 7; a power switch 8; the ODD 22; and an Eject switch 23. The display unit 3 is provided at its center portion with a display 4.

The ODD 22 has a tray for holding an optical disk and containing the optical disk in the main unit 2. At a lateral face of the tray, the Eject switch 23 for ejecting the tray contained in the main unit 2 is provided. The Eject switch 23 is pressed, thereby allowing the tray to be ejected, and allowing the optical disk held on the tray to be removed. When the ejected tray is reinserted into the main unit 2, no power has to be supplied to the ODD 22, and the tray is manually reinserted by a user.

In the personal computer 1 according to the embodiment, the supply of power to the ODD 22 can be stopped while a system is operating. A requirement for stop of supply of power to the ODD 22 is set in advance, and when the requirement is satisfied, the supply of power to the ODD 22 is stopped, thereby achieving power savings in the personal computer 1. Operations for returning the state of the ODD 22 from a power supply stop state (power OFF state) to a power supply start state (power ON state) include an operation for pressing the Eject switch 23.

However, when the supply of power is unconditionally started and the tray is ejected upon pressing of the Eject switch 23, there might arise a situation where the tray is ejected with unintended timing due to an erroneous operation performed by the user. For example, when the personal computer 1 is put in a bag and carried around, the Eject switch 23 might be pressed by mistake, and if the tray is ejected in that case, the tray is opened inside the bag, which might result in breakage of the tray. To cope with this problem, in the embodiment, the supply of power to the ODD 22 can be suitably restarted in accordance with a use status of the personal computer 1. Hereinafter, the personal computer 1 according to the embodiment will be described.

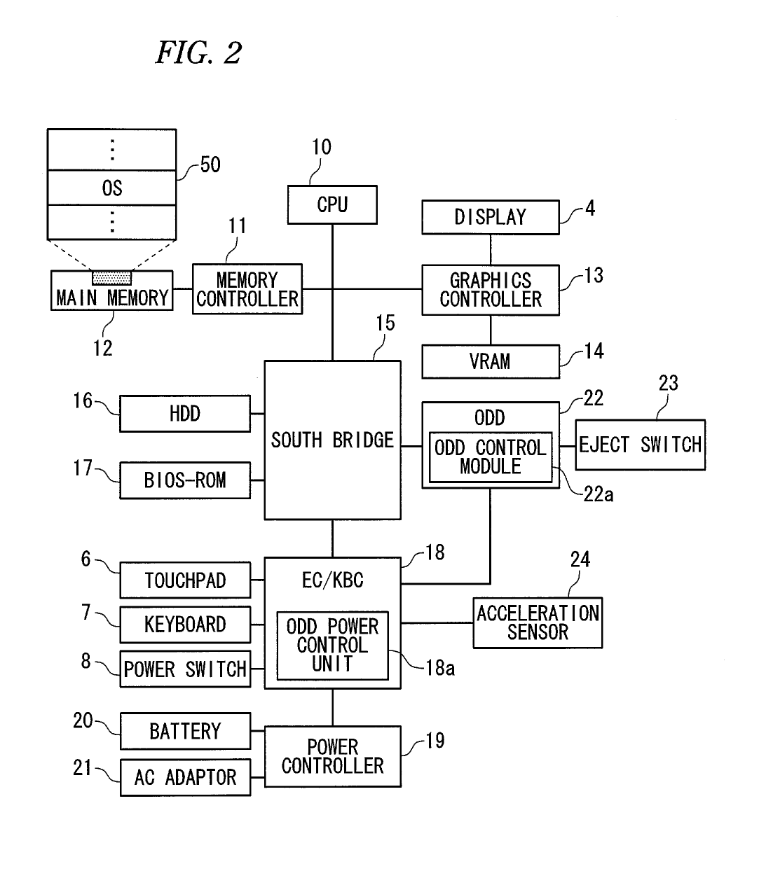

Referring to FIG. 2, functions of the personal computer 1 according to the embodiment will be described. FIG. 2 is a block diagram showing the functions of the information processing apparatus (personal computer 1) according to the embodiment.

The personal computer 1 includes: the display 4; the touchpad 6; the keyboard 7; the power switch 8; a CPU 10; a memory controller 11; a main memory 12; a graphics controller 13; a VRAM 14; a south bridge 15; a HDD 16; a BIOS-ROM 17; an EC/KBC 18; a power controller 19; a battery 20; an AC adaptor 21; the ODD 22; the Eject switch 23; and an acceleration sensor 24.

The EC/KBC 18 includes an ODD power control unit 18a, and the ODD 22 includes an ODD control module 22a.

The CPU 10 is a processor provided in order to control operations of the personal computer 1, and executes an operating system (OS 50) and various application programs loaded from the HDD 16 into the main memory 12. Further, the CPU 10 loads a system BIOS 51, which is stored in the BIOS-ROM 17, into the main memory 12, and then executes the system BIOS 51. The system BIOS 51 is a program for hardware control.

The memory controller 11 controls access to the main memory 12. The main memory 12 is a so-called working memory for decompressing the operating system (OS 50) and various application programs stored in the HDD 16, and/or the system BIOS 51 stored in the BIOS-ROM 17.

The graphics controller 13 is a display controller for controlling the display 4 used as a display monitor of the personal computer 1. From display data drawn in the VRAM 14 by the operating system and/or application programs, the graphics controller 13 generates a video signal for forming a display image that should be displayed on the display 4.

The south bridge 15 makes access to the BIOS-ROM 17, and/or controls disk drives (I/O devices) such as the HDD 16 and the ODD 22.

The HDD 16 is a storage device for storing the OS 50, various application programs, etc. The BIOS-ROM 17 is a rewritable nonvolatile memory for storing the system BIOS 51 serving as a program for hardware control.

The EC/KBC 18 controls the touchpad 6 and the keyboard 7 which function as input module. The EC/KBC 18 is a one-chip microcomputer for monitoring and controlling various devices (such as a peripheral device, a sensor and a power supply circuit) irrespective of a system status of the personal computer 1. Moreover, the EC/KBC 18 has the function of turning ON/OFF the power of the personal computer 1 in cooperation with the power controller 19 in accordance with an operation performed on the power switch 8 by the user.

The ODD power control unit 18a controls the ODD control module 22a included in the ODD 22. When the supply of power to the ODD 22 is stopped (i.e., when the ODD 22 is in the power OFF state), the ODD power control unit 18a makes reference to: acceleration information provided from the acceleration sensor 24; connection information on the AC adaptor 21, provided from the power controller 19; and operational information provided from the Eject switch 23, and restarts the supply of power to the ODD 22 based on these pieces of information.

In the embodiment, when the supply of power to the ODD 22 is stopped, a power status of the personal computer 1 may be in a suspended state or a sleep state. Furthermore, even when the personal computer 1 is in a normal operating state, the supply of power to the ODD 22 may be stopped if the power OFF function of the ODD 22 is enabled. In other words, the personal computer 1 has the function of allowing the user to set the requirement for stop of the supply of power to the ODD 22 in advance. For example, the requirement may be that when the ODD 22 is not used within a given period of time since turning ON of system power of the personal computer 1, the supply of power to the ODD 22 must be stopped. The function of setting the requirement for stop of the power supply is implemented by the ODD power control unit 18a.

When external power is supplied via the AC adaptor 21, the power controller 19 uses the external power supplied from the AC adaptor 21, thus generating system power that should be supplied to the respective components of the personal computer 1. On the other hand, when no external power is supplied via the AC adaptor 21, the power controller 19 uses the battery 20, thus generating system power that should be supplied to the respective components (e.g., the computer main unit 2 and the display unit 3) of the personal computer 1.

The power controller 19 detects whether or not the AC adaptor 21 is connected to an external power supply, and notifies the ODD power control unit 18a of a detection result via the EC/KBC 18 and the BIOS 51.

The ODD 22 is a drive for playing an optical disk. The ODD 22 has the tray for holding an optical disk, and reads the optical disk with the tray contained in the main unit, thereby reproducing various pieces of data stored on the optical disk. Specifically, a spindle motor rotates an optical disk, and an optical pickup head irradiates the optical disk with an optical beam; thus, a detection signal of light reflected from the optical disk is outputted, thereby allowing data stored on the optical disk to be read. Moreover, the tray is provided at its lateral face with the Eject switch 23 for providing an instruction for ejection of the tray.

In the embodiment, the ODD 22 is connected to the south bridge 15 and is also connected to the EC/KBC 18. Since power is supplied to the ODD 22 irrespective of the system status of the personal computer 1, the EC/KBC 18 is capable of detecting, at all times, a tray ejection instruction provided from the Eject switch 23 and inputted via the ODD 22.

The acceleration sensor 24 detects acceleration of the personal computer 1, and outputs a detection result to the EC/KBC 18. Examples of the acceleration sensor include a servo acceleration sensor, a piezoelectric acceleration sensor, an electrical capacitance acceleration sensor and a piezoresistance acceleration sensor.

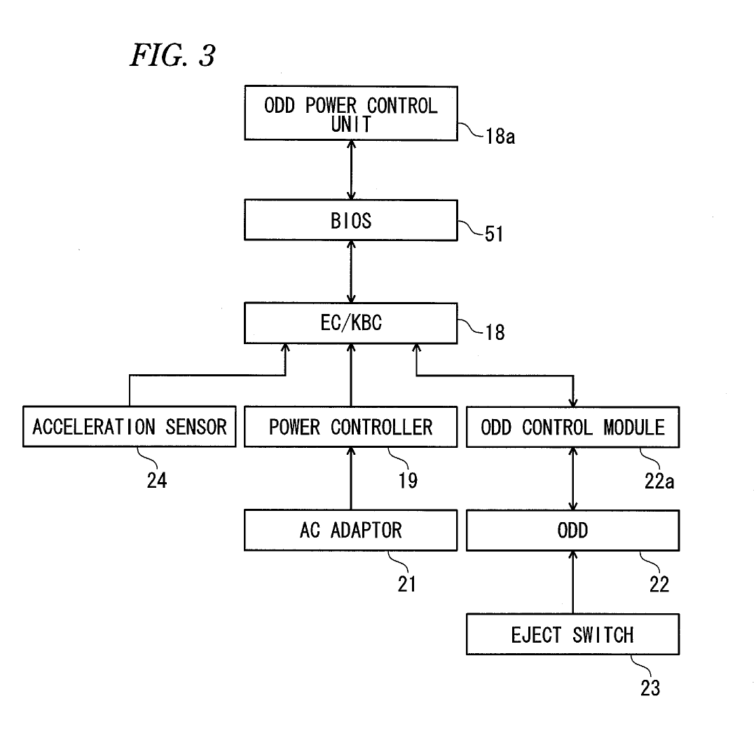

Next, referring to FIG. 3, operations of the personal computer 1 performed when the state of the ODD 22 is changed from the power OFF state to the power ON state will be described. FIG. 3 is a diagram for describing power control performed by the information processing apparatus (personal computer 1) according to the embodiment.

First, a procedure for changing the state of the ODD 22 to the power OFF state will be described. When the personal computer 1 is in the suspended state or sleep state or when the personal computer 1 satisfies the given requirement for stop of the supply of power to the ODD 22, the ODD power control unit 18a notifies, via the BIOS 51, the EC/KBC 18 of a power supply stop signal for the ODD 22. The EC/KBC 18 sends out the power supply stop signal to the ODD 22 via the ODD control module 22a, thereby turning OFF a power switch provided inside the ODD 22.

Next, a procedure for changing the state of the ODD 22 from the power OFF state to the power ON state will be described. First, the EC/KBC 18 determines whether or not a tray ejection request signal provided from the Eject switch 23 has been received. The ODD power control unit 18a is notified of the tray ejection request signal via the ODD 22, the ODD control module 22a, the EC/KBC 18 and the BIOS 51. Then, the ODD power control unit 18a obtains acceleration information from the acceleration sensor 24 via the BIOS 51 and the EC/KBC 18, and determines whether or not acceleration equal to or greater than a threshold value has been detected. Further, the ODD power control unit 18a obtains information, indicative of whether or not the AC adaptor 21 is connected to an external power supply, from the power controller 19 via the BIOS 51 and the EC/KBC 18.

Upon determination that the tray ejection request signal has been received, the acceleration equal to or greater than the threshold value has not been detected and the AC adaptor 21 is connected to an external power supply, the ODD power control unit 18a sends out a power supply start signal for the ODD 22. Upon reception of the power supply start signal for the ODD 22 via the BIOS 51, the EC/KBC 18 turns ON the power switch provided inside the ODD 22. In accordance with the above-described procedure, the supply of power to the ODD 22 is restarted by the ODD power control unit 18a.

Then, the ODD power control unit 18a notifies the ODD 22 of the tray ejection request signal via the BIOS 51, the EC/KBC 18 and the ODD control module 22a. Upon reception of the tray ejection request signal, the ODD 22 ejects the tray to outside, thereby allowing an optical disk to be removed and inserted.

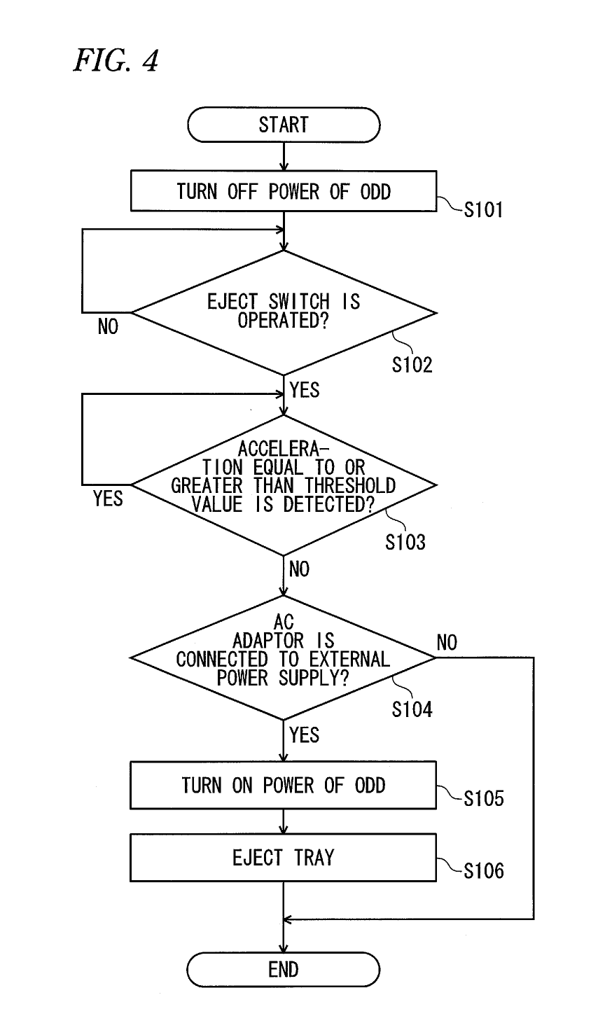

Next, referring to FIG. 4, a procedure of control performed by the personal computer 1 when the state of the ODD 22 is changed from the power OFF state to the power ON state will be described. FIG. 4 is a flow chart showing a procedure of power control performed by the information processing apparatus (personal computer 1) according to a first example of the embodiment.

First, the ODD power control unit 18a turns OFF the power of the ODD 22 (Step S101). Then, the ODD control module 22a determines whether or not an operation has been performed on the Eject switch 23 (Step S102).

Upon determination that no operation has been performed on the Eject switch 23 as a result of the determination in Step S102 (No in Step S102), the procedure returns to Step S102. On the other hand, upon determination that an operation has been performed on the Eject switch 23 as a result of the determination in Step S102 (Yes in Step S102), it is then determined whether or not acceleration equal to or greater than the threshold value has been detected by the acceleration sensor 24 (Step S103).

Upon determination that the acceleration equal to or greater than the threshold value has been detected as a result of the determination in Step S103 (Yes in Step S103), the procedure returns to Step S103. On the other hand, upon determination that the acceleration equal to or greater than the threshold value has not been detected as a result of the determination in Step S103 (No in Step S103), the ODD power control unit 18a receives, from the power controller 19, a detection result indicative of whether or not the AC adaptor 21 is connected to an external power supply, thus determining whether or not the AC adaptor 21 is connected to an external power supply (Step S104).

Upon determination that the AC adaptor 21 is not connected to an external power supply as a result of the determination in Step S104 (No in Step S104), the procedure of the power control in the embodiment ends. On the other hand, upon determination that the AC adaptor 21 is connected to an external power supply as a result of the determination in Step S104 (Yes in Step S104), the ODD power control unit 18a notifies the power switch inside the ODD 22 of a power ON signal, thereby turning ON the power of the ODD 22 (Step S105).

Then, the ODD power control unit 18a notifies the ODD 22 of a tray ejection request signal via the ODD control module 22a, thereby ejecting the tray (Step S106). Thus, the procedure of the power control in the embodiment ends.

In the first example of the embodiment implemented as described above, the supply of power to the ODD 22 can be controlled in accordance with the use status of the personal computer 1. Specifically, upon operation of the Eject switch 23 when the ODD 22 is in the power OFF state, acceleration is detected by the acceleration sensor 24, and whether or not the AC adaptor 21 is connected to an external power supply is detected. As a result, upon detection that the acceleration is below the threshold value and the AC adaptor 21 is connected to an external power supply, the supply of power to the ODD 22 is started. Specifically, when a movement of the personal computer 1 is not detected and the personal computer 1 is not driven by the battery, it is determined that the personal computer 1 is not carried around, and the supply of power to the ODD 22 is started, thereby ejecting the tray.

According to the first example of the embodiment, not only the acceleration of the personal computer 1 but also the driven state thereof are detected, thereby making it possible to more strictly determine the use status of the personal computer 1 and control the ODD 22. When whether or not the personal computer 1 is moved is determined based only on the acceleration of the personal computer 1, the tray of the ODD 22 might be ejected with unintended timing. Such trouble might occur, for example, upon erroneous pressing of the Eject switch 23 when the personal computer 1 is moved at a low speed or is at rest while being moved.

According to the first example of the embodiment, whether or not the AC adaptor 21 is connected to an external power supply is determined, thereby making it possible to more accurately determine whether or not the personal computer 1 is being moved. Specifically, even if a movement of the personal computer 1 is not detected by the acceleration sensor 24, it is determined that the personal computer 1 is being moved when the personal computer 1 is driven by the battery, and the supply of power to the ODD 22 will not be started in this case. Accordingly, the tray will not be ejected and broken by mistake.

According to the first example of the embodiment, power savings in the personal computer 1 can be achieved by forcibly stopping the supply of power to the ODD 22 in a case that the AC adaptor 21 is not connected to an external power supply. When the personal computer 1 is driven by the battery without connecting the AC adaptor 21 to the external power supply, the power of ODD 22 may be turned ON by operating an user interface displayed in the display 4.

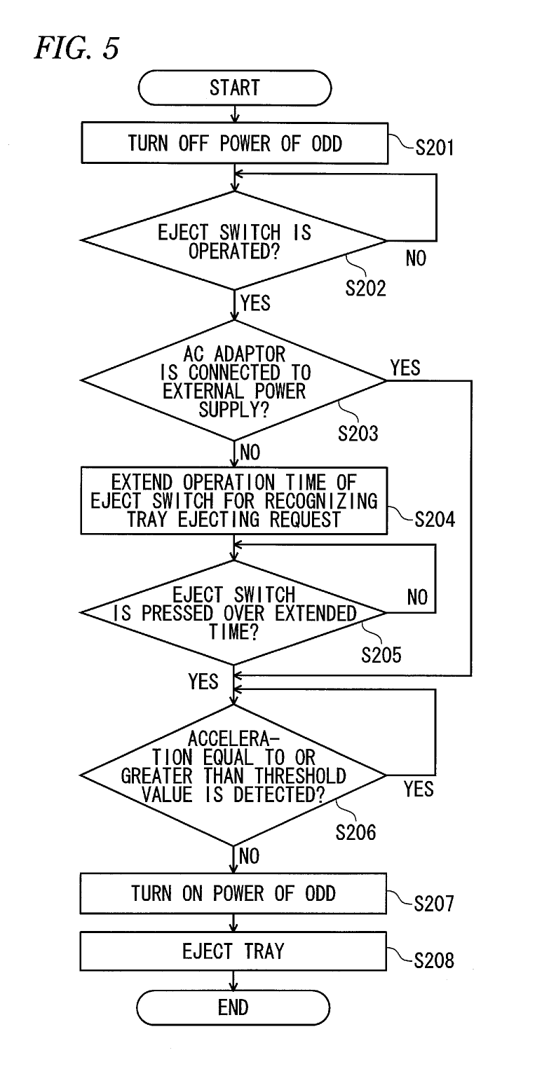

Next, referring to FIG. 5, a second example of the embodiment will be described. FIG. 5 is a flow chart showing a procedure of power control performed by the information processing apparatus according to the second example of the embodiment.

First, the ODD power control unit 18a turns OFF the power of the ODD 22 (Step S201). Then, the ODD control module 22a determines whether or not an operation has been performed on the Eject switch 23 (Step S202).

Upon determination that no operation has been performed on the Eject switch 23 as a result of the determination in Step S202 (No in Step S202), the procedure returns to Step S202. On the other hand, upon determination that an operation has been performed on the Eject switch 23 as a result of the determination in Step S202 (Yes in Step S202), the ODD power control unit 18a receives, from the power controller 19, a detection result indicative of whether or not the AC adaptor 21 is connected to an external power supply, thus determining whether or not the AC adaptor 21 is connected to an external power supply (Step S203).

Upon determination that the AC adaptor 21 is connected to an external power supply as a result of the determination in Step S203 (Yes in Step S203), the procedure proceeds to Step S206.

On the other hand, upon determination that the AC adaptor 21 is not connected to an external power supply as a result of the determination in Step S203 (No in Step S203), the ODD power control unit 18a extend an operating time of the Eject switch 23 for recognizing a tray ejection request (Step S204). That is, the ODD power control unit 18a provides a threshold value in a time for receiving a tray ejection request signal, and the ODD power control unit 18a recognizes the tray ejection request when the ODD power control unit 18a receives the tray ejection request signal over a period of time which is equal to or greater than the threshold value.

Then, the ODD power control unit 18a determines whether or not the Eject switch 23 is pressed over the extended operating time (Step S205). Upon determination that the Eject switch 23 is not pressed over the extended operating time as a result of the determination in Step S205 (No in Step S205), the procedure returns to Step S205.

On the other hand, upon determination that the Eject switch 23 is pressed over the extended operating time as a result of the determination in Step S205 (Yes in Step S205), it is then determined whether or not acceleration equal to or greater than the threshold value has been detected by the acceleration sensor 24 (Step S206).

Upon determination that the acceleration equal to or greater than the threshold value has been detected as a result of the determination in Step S206 (Yes in Step S206), the procedure returns to Step S206. That is, if it is determined that the personal computer 1 is driven by the battery and is moved, the power of the ODD 22 is not turned ON. On the other hand, upon determination that the acceleration equal to or greater than the threshold value has not been detected as a result of the determination in Step S206 (No in Step S206), the ODD power control unit 18a notifies the power switch inside the ODD 22 of a power ON signal, thereby turning ON the power of the ODD 22 (Step S20).

Then, the ODD power control unit 18a notifies the ODD 22 of a tray ejection request signal via the ODD control module 22a, thereby ejecting the tray (Step S208). Thus, the procedure of the power control in the second example of the embodiment ends.

As described above, according to the second example of the embodiment, if the personal computer 1 is driven by the battery and the movement of the personal computer 1 is not detected, the tray can be ejected only by pressing long the Eject switch 23. Since a setting OFF of the power of the ODD 22 can be canceled only by changing the operating time of the Eject switch 23, convenience for users is not detracted.

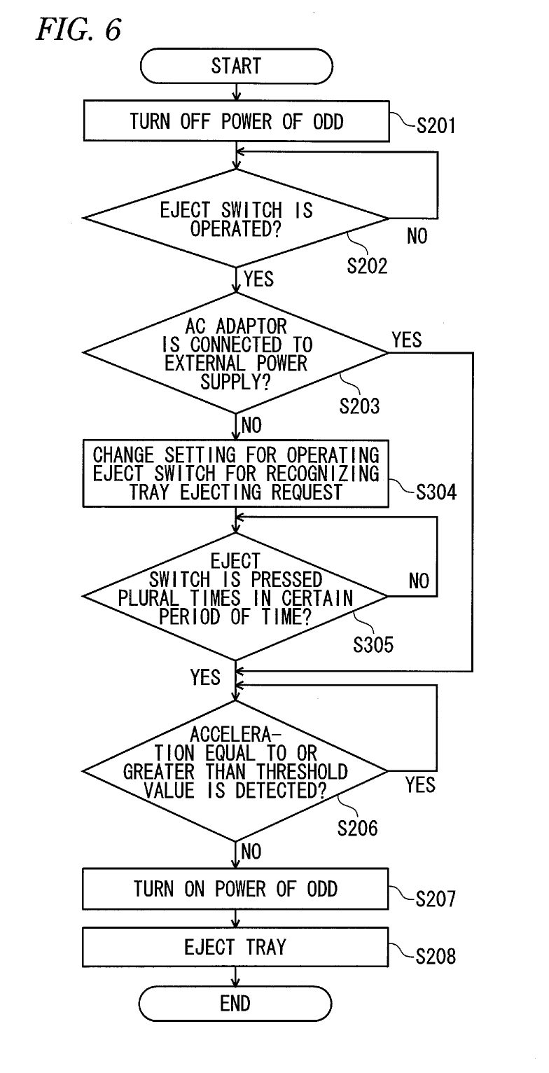

Next, referring to FIG. 6, a third example of the embodiment will be described. FIG. 6 is a flow chart showing a procedure of power control performed by the information processing apparatus according to the third example of the embodiment. The numeral references are attached to the same steps as FIG. 5, thereby omitting the detailed explanation.

Upon determination that the AC adaptor 21 is not connected to an external power supply as a result of the determination in Step S203 (No in Step S203), the ODD power control unit 18a changes a setting for an operation of the Eject switch 23 for recognizing a tray ejection request (Step S304). For example, it is set that the tray ejection request is recognized if the Eject switch 23 is pressed plural times in a certain period of time.

Then, the ODD power control unit 18a determines whether or not the operation in which the setting is changed has been performed in the Eject switch 23 (Step S305). Upon determination that the operation in which the setting is changed has not been performed in the Eject switch 23 as a result of the determination in Step S305 (No in Step S305), the procedure returns to Step S305.

On the other hand, upon determination that the operation in which the setting is changed has been performed in the Eject switch 23 as a result of the determination in Step S305 (Yes in Step S305), it is then determined whether or not acceleration equal to or greater than the threshold value has been detected by the acceleration sensor 24 (Step S206). The following procedure is the same as the explanation shown in FIG. 5, thereby omitting the explanation.

As described above, according to the third example of the embodiment, if the personal computer 1 is driven by the battery and the movement of the personal computer 1 is not detected, the tray can be ejected by pressing plural times the Eject switch 23 in a certain period of time. Since a setting OFF of the power of the ODD 22 can be canceled only by changing the operation of the Eject switch 23, convenience for users is not detracted.

While certain embodiment has been described, the exemplary embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
an optical disk device;
an optical disk device controller configured to open a tray, the tray in the optical disk device;
a receiver configured to receive a command for instructing the opening of the tray;
a detector configured to detect a movement of the information processing apparatus;
a power controller configured to control supply of power to each component of the information processing apparatus; and
a power determining module configured to determine whether the information processing apparatus is connected to an external power supply,
wherein the power controller is configured to start the supply of power to the optical disk device if the command is received while stopping the supply of power to the optical disk device, the movement is not detected, and the information processing apparatus is connected to the external power supply.

2. The apparatus of claim 1,
wherein the power controller is configured to stop the supply of power to the optical disk device if the information processing apparatus is in a normal operation state.

3. The apparatus of claim 1, wherein
the optical disk device controller is configured to change a condition for ejecting the tray if the information processing apparatus is not connected to the external power supply.

4. The apparatus of claim 1, wherein
the optical disk device controller is configured to eject the tray if the controller receives the command for instructing the opening of the tray within a period of time and if the information processing apparatus is not connected to the external power supply.

5. The apparatus of claim 1, wherein
the optical disk device controller is configured to eject the tray if the controller receives multiple commands in a period of time and if the information processing apparatus is not connected to the external power supply.

6. A power control method for an information processing apparatus including an optical disk device, the method comprising:
receiving a command for opening a tray provided in the optical disk device when stopping supply of power to the optical disk device;
detecting a movement of the information processing apparatus;
determining whether the information processing apparatus is connected to an external power supply; and
starting the supply of power to the optical disk device if it is determined that the information processing apparatus is connected to the external power supply.
